(19) United States
(12) Patent Application Publication
(10) Pub. No.: US 2021/0252867 A1
(43) Pub. Date: Aug. 19, 2021

(54) METHOD AND SYSTEM FOR PRIMING DRY PRINTHEADS

(71) Applicant: Memjet Technology Limited

(72) Inventor: Zhenya YOURLO, North Ryde NSW (AU)

(21) Appl. No.: 17/174,090

(22) Filed: Feb. 11, 2021

Related U.S. Application Data
(60) Provisional application No. 62/976,213, filed on Feb. 13, 2020.

(51) Int. Cl. B41J 2/17; B41J 2/175

(52) U.S. Cl. CPC B41J 2/1707; B41J 2/17596

(57) ABSTRACT

A system for priming a dry inkjet printhead. The system includes: the inkjet printhead having an inlet port connected to an upstream ink line and an outlet port connected to a downstream ink line; a pump operably connected to the downstream ink line; a capper engaged with printhead; a vacuum source for applying suction to a capping chamber of the capper; and a control system for coordinating actuation of the pump and the vacuum source. In use, the pump is actuated simultaneously with the vacuum source, thereby drawing ink through the printhead from the inlet port to the outlet port and priming the printhead.

### CROSS REFERENCE TO RELATED APPLICATIONS

This application claims priority to and the benefit of U.S. Provisional Patent Application No. 62/976,213, entitled METHOD AND SYSTEM FOR PRIMING DRY PRINTHEADS, filed on Feb. 13, 2020, the disclosure of which is incorporated herein by reference in its entirety for all purposes.

### FIELD OF THE INVENTION

This invention relates to method and system for priming dry printheads. It has been developed primarily for facilitating shipment of dry or unprimed pagewide printheads, which do not contain any shipping fluid.

### BACKGROUND OF THE INVENTION

Inkjet printers employing Memjet® technology are commercially available for a number of different printing formats, including small-office-home-office (“SOHO”) printers, label printers and wideformat printers. Memjet® printers typically comprise one or more stationary inkjet printheads, which are user-replaceable. For example, a SOHO printer comprises a single user-replaceable multi-colored printhead, a high-speed inkjet press comprises a plurality of user-replaceable monochrome printheads aligned along a media feed direction, and a wideformat printer comprises a plurality of user-replaceable printheads in a staggered overlapping arrangement so as to span across a wideformat pagewidth.

Replacement printheads may be shipped either ‘wet’ or ‘dry’ for installation in inkjet printers by users. Usually, printheads are shipped ‘wet’ to avoid potential problems with priming during installation. Wet-shipped printheads may be filled with either ink or a shipping fluid, which is typically an ink vehicle lacking any colorant.

However, wet-shipped printheads are less convenient for users, because ink or shipping fluid may leak from the printhead during shipment and/or spill during the installation process. Users would prefer to receive dry printheads, which are not prone to leaking or spilling fluids during shipment or installation.

However, dry-shipped printheads present challenges for ink delivery systems used to prime the dry printheads with ink. It would therefore be desirable to provide a method and system for priming a dry printhead, such as freshly installed replacement printhead in an inkjet printing system.

### SUMMARY OF THE INVENTION

As used herein, the term “ink” is taken to mean any printing fluid, which may be printed from an inkjet printhead. The ink may or may not contain a colorant. Accordingly, the term “ink” may include conventional dye-based or pigment based inks, infrared inks, fixatives (e.g. pre-coats and finishers), 3D printing fluids and the like.

As used herein, the term “printer” refers to any printing device for marking print media, such as conventional desktop printers, label printers, duplicators, copiers, digital inkjet presses and the like.

### BRIEF DESCRIPTION OF THE DRAWINGS

Embodiments of the present invention will now be described by way of example only with reference to the accompanying drawings, in which:

FIG. 1 shows schematically an ink delivery system for a printer having a replaceable inkjet printhead; and

FIG. 2 shows schematically a system for priming a dry inkjet printhead.

### DETAILED DESCRIPTION OF THE INVENTION

### Gravity-Feed Ink Delivery System

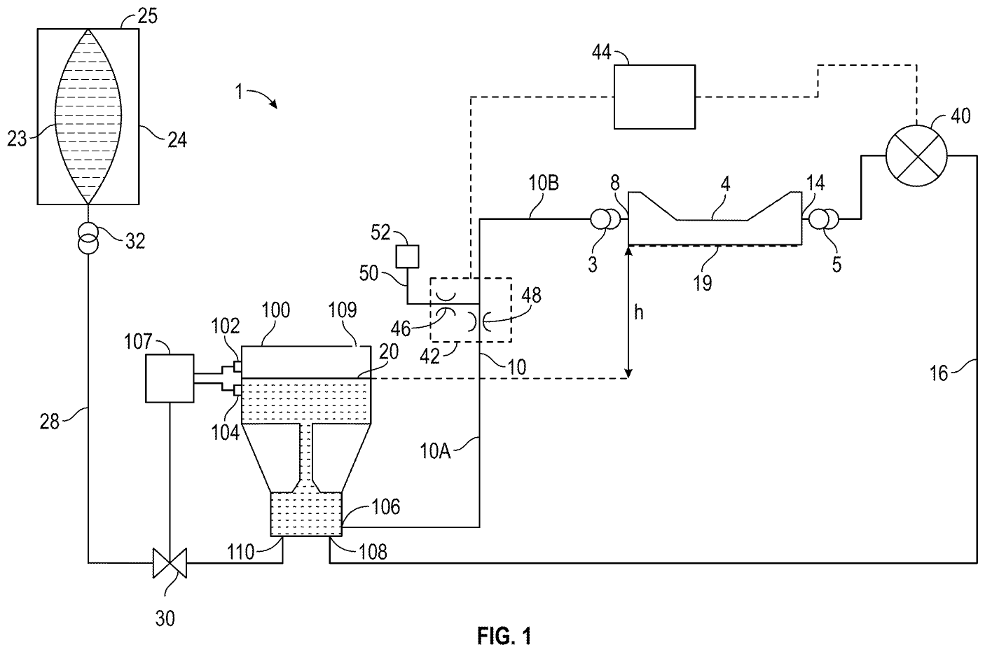

Referring to FIG. 1, there is shown schematically a printer having an ink delivery system 1 for supplying ink to a printhead 4. The ink delivery system is a gravity-feed system, which is similar in function to those described in US2011/0279566 and US2011/0279562, the contents of which are herein incorporated by reference.

The ink delivery system comprises an intermediary ink tank 100 having an ink outlet port 106 connected to a printhead inlet port 8 of a printhead 4 via a first ink line 10. An ink return port 108 of the intermediary ink tank 100 is connected to a printhead outlet port 14 of the printhead 4 via a second ink line 16. Hence, the intermediary ink tank 100, the first ink line 10, the printhead 4 and the second ink line 16 define a closed fluidic loop. Typically, the first ink line 10 and second ink line 16 are comprised of lengths of flexible tubing.

The printhead 4 is user-replaceable by means of a first coupling 3 releasably interconnecting the printhead inlet port 8 and the first ink line 10; and a second coupling 5 releasably interconnecting the printhead outlet port 14 and the second ink line 16. The printhead 4 is a typically a pagewide printhead and may be, for example, a printhead as described in US2011/0279566, U.S. Pat. Nos. 10,384,461, 10,293,609, the contents of each of which are incorporated herein by reference. Such printheads have one or more ink channels interconnecting the inlet port 8 and outlet port 14.

The intermediary ink tank 100 is open to atmosphere via a gas port in the form of an air vent 109 positioned in a roof of the tank. Accordingly, during normal printing, ink is supplied to the printhead 4 at a negative hydrostatic pressure (“backpressure”) under gravity. In other words, gravity-feeding of ink from the intermediary ink tank 100, which is positioned below the printhead 4, provides a pressure-regulating system for suppling ink to the printhead at a predetermined negative hydrostatic pressure. The amount of backpressure experienced at the nozzle plate 19 of the printhead 4 is determined by the height h of the nozzle plate above a level of ink 20 in the intermediary ink tank 100.

Ink is supplied to an ink inlet port 110 of the intermediary ink tank 100 from a bulk ink reservoir comprising a collapsible ink bag 23 housed by a cartridge 24. The cartridge 24 is open to atmosphere via a cartridge vent 25 so that the collapsible ink bag 23 can collapse as ink is consumed by the system. The collapsible ink bag 23 is typically an air-impermeable foil bag containing degassed ink, which is supplied to the ink inlet port 110 via an ink supply line 28. The cartridge 24 is typically user-replaceable and connected to the ink supply line 28 via a suitable ink supply coupling 32.

A control system is used to maintain a substantially constant level of ink in the intermediary ink tank 100 and, therefore, a constant height h and corresponding backpressure. As shown in FIG. 1, a control valve 30 is positioned in the ink supply line 28 and controls a flow of ink from the cartridge 24 into the intermediary ink tank 100. The control valve 30 is operated under the control of a first controller 107, which receives feedback from ‘high’ and ‘low’ sensors 102 and 104 (e.g. optical sensors) positioned at a sidewall of the intermediary ink tank 100. When the level of ink 20 falls below the ‘low’ sensor 104, the first controller 107 signals the valve 30 to be opened, and when the level of ink reaches the ‘high’ sensor 102, the controller signals the valve to close. In this way, the level of ink 20 in the intermediary ink tank 100 may be maintained relatively constant. The intermediary ink tank 100 may be as described in, for example, U.S. Pat. No. 10,427,414, the contents of which is incorporated herein by reference.

The closed fluidic loop, incorporating the intermediary ink tank 100, the first ink line 10, the printhead 4 and the second ink line 16, facilitates priming, de-priming and other required fluidic operations. The second ink line 16 includes a peristaltic pump 40 for circulating ink around the fluidic loop in clockwise direction as shown in FIG. 1.

The pump 40 cooperates with a pinch valve arrangement 42 to coordinate various fluidic operations. The pinch valve arrangement 42 comprises a first pinch valve 46 and a second pinch valve 48, and may take the form of any of the pinch valve arrangements described in, for example, US 2011/0279566; US 2011/0279562; and U.S. Pat. No. 9,180,676, the contents of which are incorporated herein by reference.

The first pinch valve 46 controls a flow of air through an air conduit 50, which is branched from the first ink line 10. The air conduit 50 terminates at an air filter 52, which is open to atmosphere and functions as an air intake for the closed fluidic loop when required.

By virtue of the air conduit 50, the first ink line 10 is divided into a first section 10a between the ink outlet port 106 and the air conduit 50, and a second section 10b between the printhead inlet port 8 and the air conduit 50. The second pinch valve 48 controls a flow of ink through the first section 10a of the first ink line 10.

The pump 40, the first pinch valve 46 and the second pinch valve 48 are controlled by a second controller 44, which coordinates various fluidic operations. From the foregoing, it will be appreciated that the ink delivery system shown in FIG. 1 provides a versatile range of fluidic operations. Table 1 describes various pinch valve and pump states for some example fluidic operations used in the printer 1. Of course, various combinations of these example fluidic operations may be employed.

TABLE 1
Example Fluidic Operations for Printer 1

| Fluidic | Second Pinch | First Pinch | First |
|---|---|---|---|
| Operation | Valve 48 | Valve 46 | Pump 40 |
| PRINT | open | closed | off |
| PRIME | open | closed | on |
| STANDBY | open | closed | off |
| DEPRIME | closed | open | on |
| NULL | closed | closed | off |

During normal printing (“PRINT” mode), the printhead 4 draws ink from intermediary ink tank 100 at a negative backpressure under gravity. In this mode, the peristaltic pump 40 functions as a shut-off valve, whilst the first pinch valve 46 is closed and the second pinch valve 48 is open to allow ink flow from the ink outlet port 106 to the first port 8 of the printhead 4. During printing, ink is supplied to the ink inlet port 110 of the intermediary ink tank 100, under the control of the first controller 107, to maintain a relatively constant backpressure for the printhead 4.

During printhead priming or flushing (“PRIME” mode), ink is circulated around the closed fluidic loop in the forward direction (i.e. clockwise as shown in FIG. 1) with the control valve 30 closed. In this mode, the peristaltic pump 40 is actuated in the forward pumping direction whilst the first pinch valve 46 is closed and the second pinch valve 48 is open to allow ink flow from the ink outlet port 106 to the ink return port 108 via the printhead 4. Priming in this manner may be used to prime a printhead with ink.

In the “STANDBY” mode, the pump 40 is switched off whilst the first pinch valve 46 is closed and the second pinch valve 48 is open. The “STANDBY” mode maintains a negative hydrostatic ink pressure at the printhead 4, which minimizes color mixing on the nozzle plate 19 when the printer is idle. Usually, the printhead is capped in this mode to minimize evaporation of ink from the nozzles (see, for example, US2011/0279519, the contents of which are herein incorporated by reference).

In order to replace a spent printhead 4, it is necessary to de-prime the printhead before it can be removed from the printer. In the “DEPRIME” mode, the first pinch valve 46 is open, the second pinch valve 48 is closed and the first pump 40 is actuated in the forward direction to draw in air from atmosphere via the air conduit 50. Once the printhead 4 has been deprimed of ink, the printer is set to “NULL” mode, which isolates the printhead from the ink supply, thereby allowing safe removal of the printhead with minimal ink spillages.

From the foregoing, it will be appreciated that a number of fluidic operations may be performed using the ink delivery system described above in connection with FIG. 1.

### Priming Dry Printhead 4

The ink delivery system described in connection with FIG. 1 is highly suitable for priming a wet printhead—that is, a printhead typically primed with a shipping fluid. In the ‘PRIME’ mode, the pump 40 is actuated in the forward direction so as to draw ink into the printhead 4 through the inlet port 8. In this way, the shipping fluid is displaced from the printhead 4 and circulates clockwise around the ink delivery system back to the intermediary tank 100 via the second ink line 16. (Any dilution of ink by the shipping fluid is virtually unnoticeable to the user, or quickly mitigated by spitting ink from the printhead 4).

However, dry printheads are less suitable for priming using the ink delivery system shown in FIG. 1. This is because actuation of the pump 40 in the forward direction tends to suck air into the printhead 4 via ink ejection nozzles instead of drawing fresh ink into the printhead through the inlet port 8. The problem is particularly exacerbated in longer printheads e.g. printheads longer than 200 mm or printheads longer than 250 mm One means for overcoming this problem of priming dry printheads is to seal the nozzles so as to prevent air being sucked into the printhead 4. Printhead cappers are well known to those skilled in the art and are designed to inhibit dehydration of ink from nozzles during idle periods (see, for example, the capper described in U.S. Pat. No. 10,518,536, the contents of which is incorporated herein by reference). However, cappers rarely provide a perfect hermetic seal around a printhead nozzle plate, especially in longer printheads. Indeed, many cappers are provided with a small breather hole to equalize pressure inside and outside the capping chamber, thereby enabling the capper to be easily uncapped from the printhead when required. Therefore, simply capping the printhead 4 is usually not an adequate solution to the problem of air being sucked into nozzles when attempting to prime the printhead.

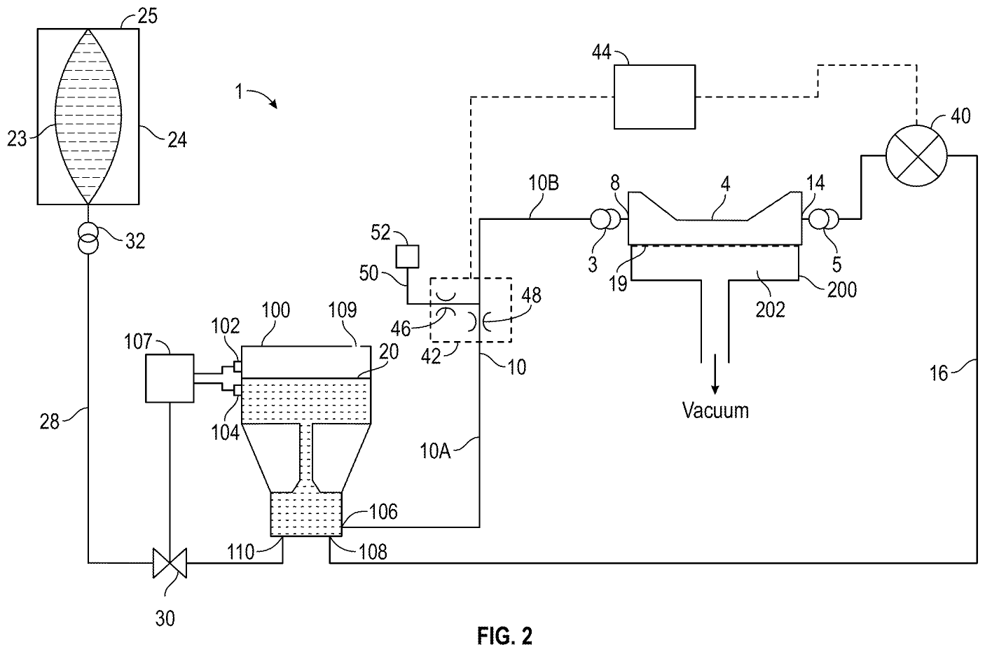

In FIG. 2, there is shown a system suitable for priming a dry printhead 4. In this system, the printhead 4 is capped by a capper 200 during priming; additionally, suction is applied to the capper 200 via a suitable vacuum source (e.g. vacuum pump) connected to the capping chamber 202.

Therefore, when the pump 40 is actuated in the forward direction, according to the ‘PRIME’ operation described above, air cannot be sucked into the printhead 4 through the nozzles. Rather, the small vacuum pressure maintained in the capping chamber 202 of the capper 200 allows ink to be drawn into the printhead 4 via the inlet port 8, as desired, thereby priming ink channel(s) in the printhead with ink. The amount of suction is controlled so as to be sufficient to overcome a pressure exerted by the pump at the nozzles of the printhead. However, the amount of suction is controlled so as to be insufficient to draw ink through the nozzles of the printhead into the capper 200. Thus, ink channel(s) in the printhead 4 interconnecting the inlet port 8 and outlet port 14 may be primed with ink.

The second controller 44 may be used to control the amount of suction in the capping chamber 200 in concert with actuation of the pump 40. In this way, priming of dry printheads is achievable using an ink delivery system of the type that does not rely on forced one-way flow of ink through the printhead 4.

It will, of course, be appreciated that the present invention has been described by way of example only and that modifications of detail may be made within the scope of the invention, which is defined in the accompanying claims.

1. A system for priming a dry inkjet printhead, said system comprising:
the inkjet printhead having an inlet port connected to an upstream ink line and an outlet port connected to a downstream ink line;
a pump operably connected to the downstream ink line;
a capper engaged with the printhead;
a vacuum source for applying suction to a capping chamber of the capper; and
a control system for coordinating actuation of the pump and the vacuum source,
wherein, in use, the pump is actuated simultaneously with the vacuum source, thereby drawing ink through the printhead from the inlet port to the outlet port and priming the printhead.

2. The system of claim 1 further comprising an ink tank, wherein the upstream and downstream ink lines are connected to the ink tank to form a closed fluidic loop with the printhead.

3. The system of claim 2, wherein the ink tank is replenishable from a bulk ink supply.

4. The system of claim 3, wherein the ink tank is positioned below a height of the printhead for gravity control of ink pressure in the printhead.

5. The system of claim 1, wherein the pump is a one-way pump.

6. The system of claim 5, wherein the pump is an inline peristaltic pump.

7. The system of claim 1, wherein the suction is sufficient to overcome a pressure exerted by the pump at the nozzles of the printhead.

8. The system of claim 1, wherein the suction is insufficient to draw ink through nozzles of the printhead.

9. A method of priming a dry inkjet printhead having an inlet port and an outlet port, said method comprising the steps of:
applying suction to nozzles of the printhead; and
pumping ink through the printhead from the inlet port to the outlet port,
wherein the suction is insufficient to draw ink through the nozzles.

10. The method of claim 9, wherein the suction is sufficient to overcome a pressure exerted by the pump at the nozzles.
